(19) United States
(12) Patent Application Publication
(10) Pub. No.: US 2002/0040375 A1
(43) Pub. Date: Apr. 4, 2002

(54) Method of organizing digital images on a page

(76) Inventors: Richard A. Simon, Rochester, NY (US); Dale F. McIntyre, Honeoye Falls, NY (US)

Correspondence Address: Patent Legal Staff, Eastman Kodak Company, 343 State Street, Rochester, NY, 14650-2201, US

(21) Appl. No.: 09/825,453

(22) Filed: Apr. 3, 2001

Related U.S. Application Data
(63) Continuation-in-part of application No. 09/559,478, filed on Apr. 27, 2000.

(51) Int. Cl. G06F 17/24

(52) U.S. Cl. 707/517; 707/520

(57) ABSTRACT

A system, software product and method for organizing a plurality of digital images in a predetermined page format. The digital images are grouped in a plurality of different page layouts. The page layouts are analyzed in accordance with a predetermined criteria. A page layout is selected based on the predetermined criteria.

### CROSS REFERENCE TO RELATED APPLICATIONS

This is a continuation-in-part of application Ser. No. 09/559,478, filed 27 April 2000, entitled: “METHOD OF ORGANIZING DIGITAL IMAGES ON A PAGE” by Richard A. Simon.

### FIELD OF THE INVENTION

The present invention relates to a method, system and computer software program for automatically organizing digital on a page that is especially useful when images of various sizes are presented for placement on the page.

### BACKGROUND OF THE INVENTION

Photographic albums provide a way to store, organize, and display pictorial information. Typically this pictorial information corresponds to important life memories of the individual who created the photographic album. These memories can correspond to photographs, and keepsakes and mementos such as, greeting cards, invitations, hand drawn images, etc. Each year an extremely large number of photographs are developed, looked at and stuffed in a drawer or shoebox. Digital images suffer the same fate as their hardcopy cousins except in this case they are “stuffed onto” digital storage devices such as hard drives and CD-ROMS. The individual usually has good intentions of creating a photo album, but never quite gets around to it. This is because the process of creating a photo album is a time consuming, difficult deed that usually provides less than satisfactory results.

Typically the process of creating a photo album is done by either cutting and attaching hardcopy images onto an album page or by scaling, cropping, and inserting digital images into album pages via commercially available imaging software such as Microsoft PictureIt™. One important step in creating an album page is the ability to easily arrange and fit the desired number of digital images on the album page. One way of simplifying the process of arranging digital images is to use templates that have predefined locations for the images. Templates provide an easy way to album images but they are not always efficient in their use of space. With templates the selected images are either proportionately sized or cropped and sized to fit in the selected location in the template. Proportionately sizing the image to fit a template can lead to considerable space being wasted on the album page. The process of cropping an image to fit a template can lead to important pictorial information being cut out of the image. A further disadvantage to templates is the user can only choose from the available templates. If there are no acceptable templates available, the user is forced to resort to the tedious process of individually scaling, cropping, and placing the images on the page until an acceptable arrangement is found. With the advent of Advanced Photo System, digital scanners, digital cameras, and digital image editing software, digital images can have a multitude of various aspect ratios. This can make the process of arranging images on a page even more challenging. In addition, it is impossible to have templates that can facilitate all the possible combination of images.

The present invention solves many of the problems of the prior art. It provides an easy and efficient way of arranging digital images of various size aspect ratios on an album page. In addition, the current invention provides the user with an easy way to generate a large number of different arrangements of the same images and thus allowing the user to choose a preferred arrangement.

### SUMMARY OF THE INVENTION

The above, and other objects, advantages and novel features of the present invention will become more apparent from the accompanying detailed description thereof when considered in conjunction with the following drawings.

In accordance with one aspect of the present invention there is provided a method of organizing a plurality of images including at least one image placeholder in a predetermined page format, comprising the steps of:

grouping the plurality of images into a plurality of different page layouts, wherein the plurality of images are not placed in the placeholder;

analyzing each of the different page layouts in accordance with a predetermined criteria; and

selecting the page layout based on the predetermined criteria.

In accordance with another aspect of the present invention there is provided a method of organizing a plurality of images in a predetermined page format including a background image, comprising the steps of:

identifying an image to be used as a background image;

grouping the plurality of images into a plurality of different page layouts including the background image;

analyzing each of the different page layouts in accordance with a predetermined criteria; and

selecting the page layout based on the predetermined criteria.

In accordance with another aspect of the present invention there is provided a computer software product for organizing a plurality of images in a predetermined format comprising a computer readable storage medium having a computer program which when loaded into a computer causes the computer to perform the following steps:

grouping the plurality of images into a plurality of different page layouts; wherein the plurality of images are not placed in a predefined area on the page;

analyzing each of the different page layouts in accordance with a predetermined criteria; and

selecting the page layout based on the predetermined criteria.

In accordance with yet another aspect of the present invention there is provided a method of organizing a plurality of images in a predetermined page format, comprising the steps of:

providing a plurality of digital images;

providing at least one image placeholder;

selecting a number of the images and the at least one image placeholder for placement on the predetermined format;

grouping the plurality of images and the image placeholder into a plurality of different page layouts;

analyzing each of the different page layouts in accordance with a predetermined criteria; and

selecting the page layout based on the predetermined criteria.

In accordance with yet another aspect of the present invention there is provided a method of organizing a first set of plurality of images in a predetermined page format, comprising the steps of:

grouping the plurality of images into a plurality of different page layouts, wherein the plurality of images are not placed in the placeholder;

analyzing each of the different page layouts in accordance with a predetermined criteria;

selecting the page layout based on the predetermined criteria; and

storing the selected page layout for later use.

### BRIEF DESCRIPTION OF THE DRAWINGS

In the detailed description of the preferred embodiments of the invention presented below, reference is made to the accompanying drawings in which:

FIG. 1 is a schematic diagram of a system for practicing the present invention;

FIG. 2 is a page having a template layout in accordance with the prior art;

FIG. 3 is plan view of a plurality of images for placement on an page;

FIG. 4 is a plan view of the page of FIG. 2 having the images of FIG. 3 placed thereon;

FIG. 5 flow chart of a method for determining a page layout for a plurality of images in accordance with the present invention;

FIG. 6 is plan view of the format of a page on which the images of FIG. 3 are to be placed in accordance with the present invention;

FIG. 7 is a flow chart illustrating one of the steps in calculating the page layout method of FIG. 5;

FIG. 8 is an initial image page layout of the images to be placed on the page;

FIG. 9 is a modified image page layout of FIG. 8 after further manipulation;

FIG. 10 is a modified image page layout of FIG. 9 after yet still further manipulation;

FIGS. 11-15 illustrate yet further manipulation that may be made to the image page layout;

FIG. 16 is flow chart of a method of providing further image page manipulation; and

FIG. 17 is a page layout including a background image with an image placeholder to preserve an area of interest.

### DETAILED DESCRIPTION OF THE INVENTION

In the present invention, the term page as used herein is meant to include an album or scrapbook page, poster, soft copy display, or any other format where images are displayed.

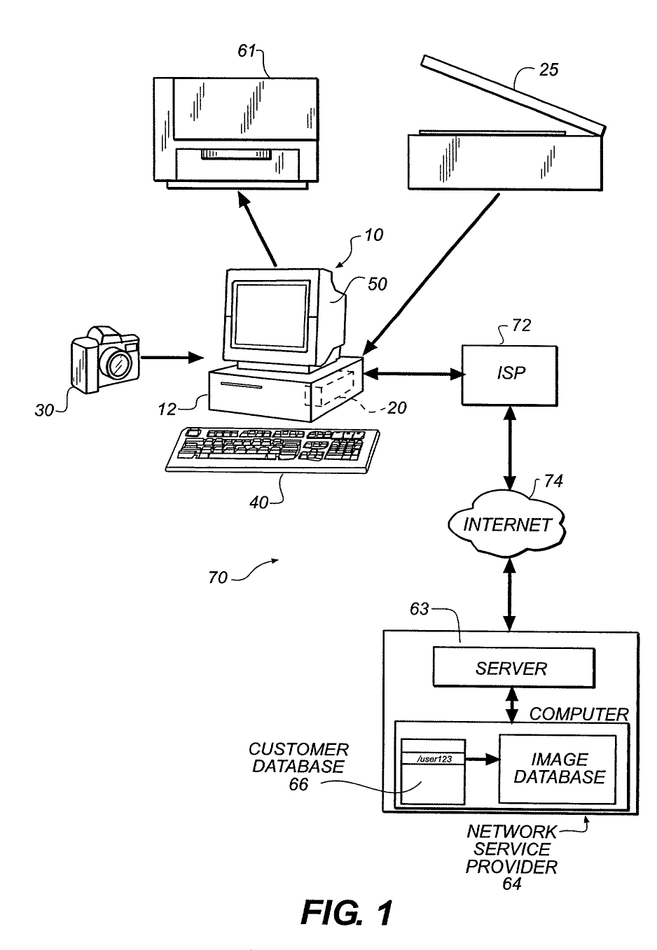

FIG. 1 illustrates a system 10 that can be useful in practicing the present invention. The system 10 includes a personal computer (PC) 12 containing a central processing unit (CPU) that can execute a set of predefined steps in carrying out the method of the present invention. A digital storage media 20 is also provided in PC 12 for storing digital images. The digital storage media 20 can include different types of devices, such as RAM, ROM, hard and floppy drives, etc. The digital storage media 20 can also be used to store the generated image page. In addition, digital image capture devices such as scanner 28 and digital cameras 30, which are additional sources of digital images, can also be provided to the PC 12. It is to be understood that the digital images may be obtained from any source. A user interacts with the PC 12 via input devices 40, such as a mouse and/or keyboard, and a display monitor 50 that is connected to the PC 12. The system 10 may also contain a device such as a printer 61 for outputting the image page. Alternatively, the above components do not have to all reside on the PC 12 but can reside on a server 63 located at a network service provider 64 which can be connected via a communication network 70. The communication network 70 may comprise the Internet 74 which can be accessed by an individual using an Internet Service Provider (ISP) 76. The network service provider 64 may also include a customer database 66 for storing information regarding customers and a image storage data base for storing of digital images provided by the customer either by the internet 74 or by any other means. The service provider 64 will be equipped to provide goods and/or services as described herein or any other goods and/or services desired. The remote network service provider may also be accessed by a customer using a retail kiosk or any other appropriate communication device.

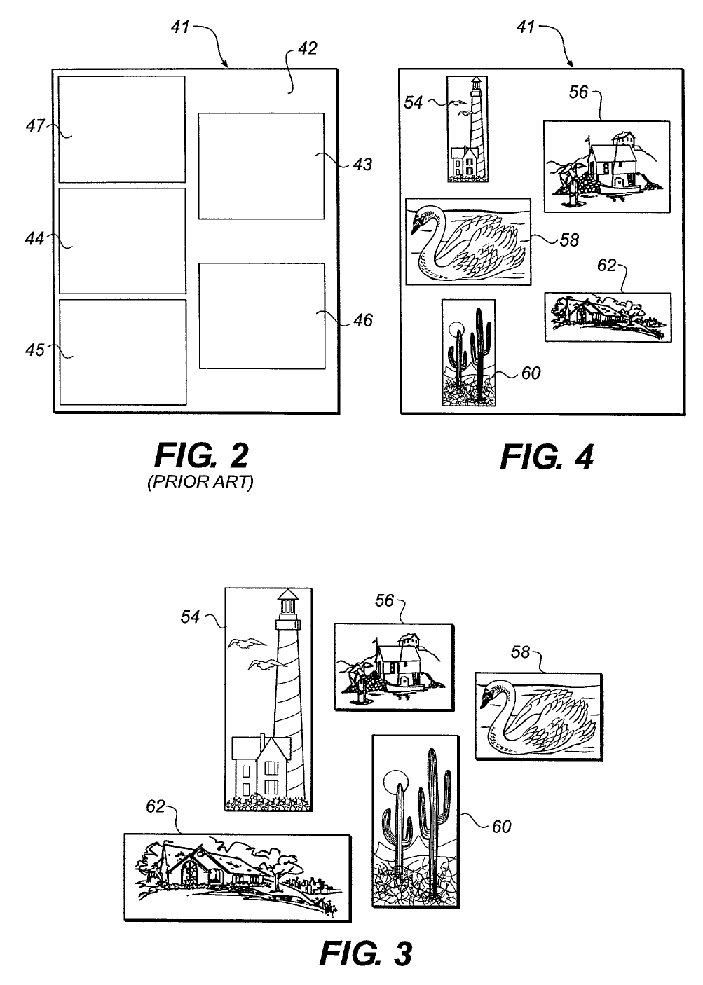

Referring to FIG. 2 there is illustrated a prior art, a page 41 that incorporates a template 42 made in accordance with the prior art. The template 42 comprises a plurality of predefined locations 43-47 for the placement of images that are used to simplify the process of arranging images on a page. A weakness of using pages with a predefined template becomes very apparent when the images selected to be arranged on the page have very diverse aspect ratios. FIG. 3 shows five images 54, 56, 58, 60, and 62 that are to be arranged on a page and FIG. 3 shows a page that has predefined locations for the five images. FIG. 4 shows the results of proportionately sizing the images to fit in template 42. As can be seen, this leads to a considerable amount of space on the page being squandered. That is, large areas of the page are void of images. In addition the size of the images are substantially reduced when they are sized to fit the location.

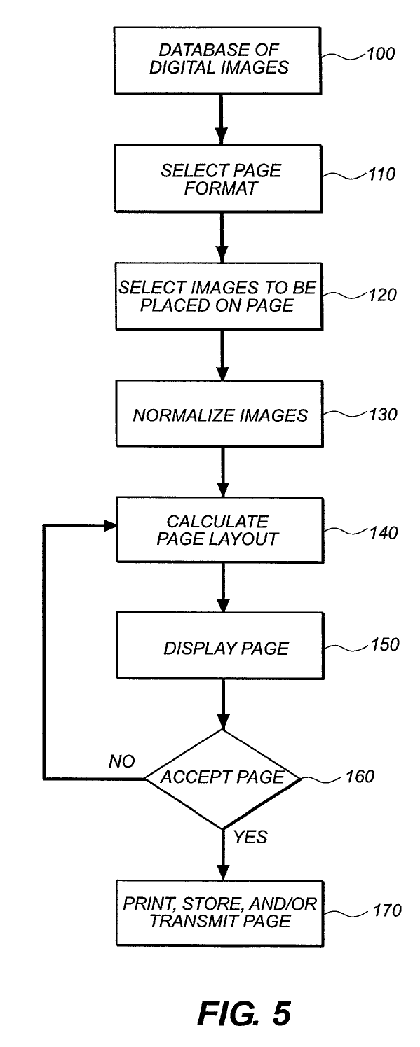

FIG. 5 is a schematic flow chart illustrating the method of constructing an image page layout according to the present invention using computer software program made in accordance with the present invention. A plurality of digital images (such as shown by FIG. 3) that can be placed on an image page are stored in a database at step 100. In the present invention, digital images refers not only to images obtained from photographs, but to digital images obtained from any source, for example but not by way of limitation, a digital camera, scanning of a hard copy document, or electronically from another source. Another form of a digital image may comprise a predefined area that is used as an image placeholder. Such an image placeholder has a dimension and/or shape that may selected by a customer, is treated as a “blank” image and causes an intentional space void of images in the image page layout.

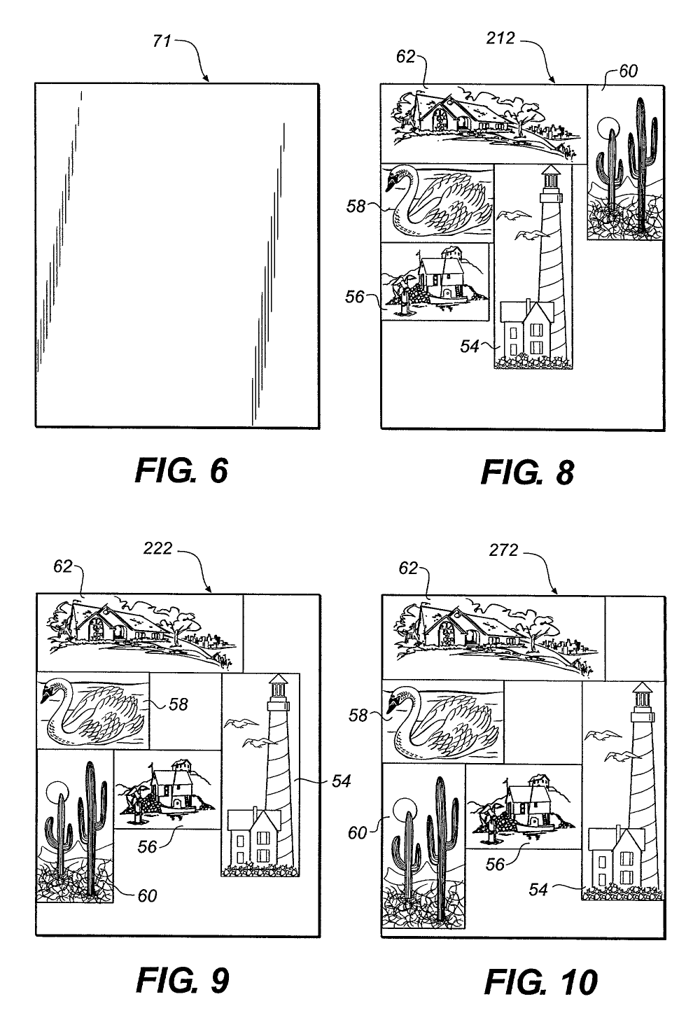

Continuing with FIG. 5, the format of a page 80 (see FIG. 6) on which the images 54, 56, 58, 60, and 62 are to be arranged is selected at step 110 by either specifying the height and width of the page or alternatively the aspect ratio (i.e. width/ height or height/width) of the page can be specified. The digital images to be arranged on the image page are then selected at step 120 either manually, semi-automatically, or automatically from the database where the images are stored. The semi-automatic and automatic selection process, can make use of data, such as time and date, that is recorded along with images and digital image processing techniques, such as image content analysis, to help select relevant images that should appear on a given image page. Optionally, the images 54, 56, 58, 60, and 62 to be arranged on the page can be normalized at step 130. Normalizing the images prevents one image from spatially dominating the page layout. This is especially true when one image is much larger or smaller than the rest of the images. A preferred normalization is one in which the images are isotropically scaled so that their shortest dimension (height or width) are all equivalent. The normalized height and width of the images to be arranged on the image page and the format of the image page are passed to the page layout subroutine 140. The layout subroutine 140 calculates a page layout of the images on the image page 80 and displays 150 the results on display monitor 50. At this point, the user can either accept 160 the image page layout or iterate through the page layout subroutine 140 until an acceptable image page is obtained. When an acceptable image page layout is obtained at step 170, the image page layout and images may be stored on the PC 12, printed by printer 61, or transmitted to another site via the network 70 where they can be stored, printed or viewed by another person.

The user, upon reaching an acceptable page layout may choose to store a template of the page layout for future use instead of iterating through page layout subroutine 140. In this case, parameters of the page layout such as number of images, orientation, physical location on the page, and magnification factors are stored in a template file on PC 12 through the use of digital storage media 20. In the case where backgrounds are used in a page layout, the template file can include the filename of a background, a background identification number or any of a multitude of other methods to retrieve the appropriate background.

The job of the page layout subroutine 140 is to fit a given number n of images on a given image page to obtain a suitable page layout using a predetermined criteria. In the embodiment illustrated the predetermined criteria comprised fitting the n images onto the image page in such a way that minimizes the white space. The white space, which is the area of the image page not covered by an image, is defined by the following relationship:

White Space=1.0−(total image area)/(page area) EQ. #1

Wherein: the total image area is the sum of the area of the individual images to be placed on the page; and

the page area is the area as defined by the height H and Width W allowed for placement of the images. Generally, the page area would be the entire page.

The page layout subroutine 140 may take into account the aesthetic considerations of the image page layout. One important aesthetic consideration is the spatial balance of the images on the page. Spatial balance is a measure of how equally distributed the images are on the image page.

The problem of generating an acceptable image page layout that contains n images can be formulated as a combinatorial optimization problem. The most practical way of solving combinatorial optimization problems is to use stochastic algorithms, such as simulated annealing or genetic algorithms. These combinatorial optimization algorithms along with other optimization algorithms are described in Iterative Computer Algorithms with Applications in Engineering: Solving Combinatorial Optimization Problems by Sait, S. M. and Youssef, H., IEEE Computer Society, Los Alamitos, Calif., 1999.

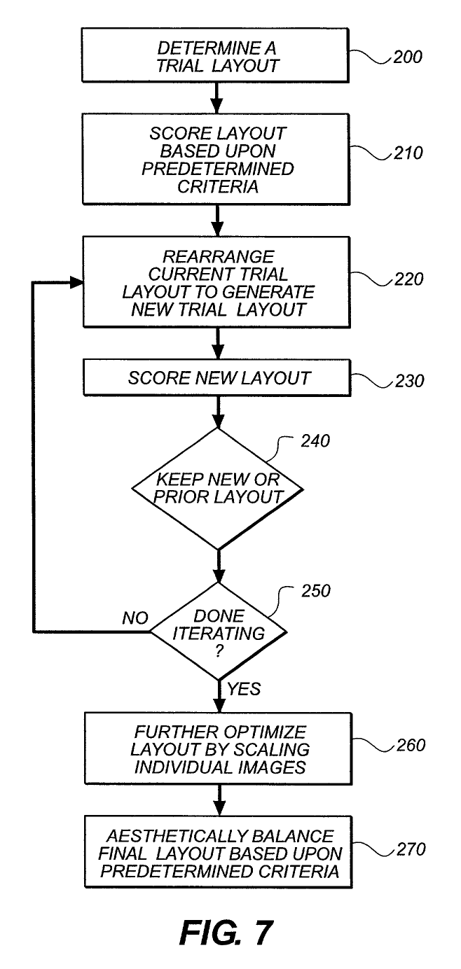

Referring to FIG. 7, there is shown a preferred embodiment of a flow chart for a page layout subroutine 140 for calculating the layout of the images on a page according to the present invention. The subroutine 140 in the embodiment illustrated is automatically executed by a computer software program that is separate or part of a larger software program for executing the method of FIG. 5. It is to be understood that the page layout subroutine 140 may be executed by a variety of alternative methods and optimization techniques. The height and width of the n images to be arranged on the page and the format of the page are passed to the page layout subroutine 140. A trail page layout 212 is generated that contains all n images such that no two images overlap.

In the embodiment illustrated, two useful methods that can each be used for generating non-overlapping placement of the images on a page, are the sequence pair and bounded sliceline grid BSG structures. The sequence pair structure is described in H. Murata, K. Fujiyoshi, S. Nakatake, and Y. Kajitani, “VLSI subroutine placement based on rectangle-packing by the sequence pair,” IEEE Trans. Computer-Aided Design, vol. 15, pp. 1518-1524, December 1996 and the BSG structure is described in S. Nakatake, K. Fujiyoshi, H. Murata, and Y. Kajitani, “Subroutine placement on BSG-structure and IC layout applications,” Proc. IEEE Int. Conf: Computer-Aided Design, pp. 484-491, 1996.

At step 200, the trail page layout 212 is generated by using one of the above methods to produce a non-overlapping placement of the n images on a plane and then isotropically scaling (i.e. the width and height are scaled by the same proportion) each image by the same proportion so as to fit onto the chosen page format. FIG. 8 illustrates a trail page layout 212 that contains the five images shown in FIG. 3. The trail page layout 212 is then scored by at step 210 by a cost (or objective) function. In the preferred embodiment the cost function is equal to the white space as defined by EQ. #1.

The goal of the optimization is to find a page layout that minimizes the cost function. In the preferred embodiment a simulated annealing approach is used to find an optimal page layout. For simulated annealing, a modification or change is made to the current trial page layout 212 to generate a new trial page layout 222 (see FIG. 9) at step 220. New trail page layout 222 is generated by randomly changing the relative positions of the images in the current trail page layout 212. The new trail page layout 222 is then scored at step 230 by the cost function. FIG. 9 illustrates the new trial page layout 222 that was generated by randomly perturbing the page layout shown in FIG. 8. From herein the prior trail page layout refers to the trail page layout that was modified to generate the next new trail page layout.

A determination is made as whether to keep the new trail page layout 222 or the prior trail page layout 212 at step 240. The new trial page layout 222 is accepted if its score is lower than the score of the prior trial page layout 212. Also, if the score for the new page layout 222 is greater than the score the prior page layout 212, the new page layout 222 is kept with a defined probability of exp[-(Δscore)/T] where Δscore=(score of new page layout—source of prior page layout). The parameter T is used to adjust the probability of keeping a new page layout. The optimization process is iterated at steps 220, 230, 240, and 250 until the last iteration is obtained. The last iteration can be defined by the total number of iterations or by a number of iterations without an improvement. It is to be understood that any desired criteria may be used for determining when no further iteration is needed or desired.

Optionally, further improvements in the calculated page layout can be made by further scaling the images by different amounts so to further minimize the white space. Once again a simulated annealing approach may be used. A new trail page layout is generated by randomly selecting an image and scaling it by a random factor between a minimum factor scale1 and a maximum factor scale2 while respecting the relative positions of the images imposed by the page layout calculated by iterating through steps 220, 230, 240 and 250. Scale1 represents the lower scaling limit and scale2 represents the upper scaling limit. By varying the scale limits scale1 and scale2, page layouts can be generated that possess very different artistic look and feel. A small magnitude difference between the scaling factors scale1 and scale2 (e.g. scale1=0.9 and scale2=1.1) ensures that no one image will overwhelm another image on the page. A large magnitude difference between scale1 and scale2 can lead to optimized page layouts with very little white space where the images have very diverse sizes. A new page layout 272 is scored and compared to the prior page layout to determine which page layout to keep. Through an iterative process of modifying, scoring, and comparing a new page layout 272 such as shown in FIG. 10 is determined at step 260. In the new optimum page layout of FIG. 10 was generated by scaling each image in the page layout shown in FIG. 9 by random factors between 0.9-1.1.

In a further optionally step 270, the images in the page layout can be aesthetically balanced. Aesthetic considerations play a role determining what makes a visually appealing page layout to an individual. There are many different artistic looks and feels that a page layout can possess and is very personal. In a preferred embodiment, the images are aesthetically balanced by positioning them on the page so that they are equally distributed on the page with visually appealing borders between each image and the border of the page while still preserving the amount of white space. For example, but not by way of limitation, the images are positioned on the page such that the left and right borders (space) 273, 274 between an image and the next closest image or boundary (peripheral edge) of the page are made equal as shown in FIG. 12. The same is done for the top and bottom borders 275, 277 of the images as shown in FIG. 12. Note that the left/right 273, 274 and bottom/top 275, 277 borders of the images do not necessarily have to be equal. In addition, images that are close to the boundary of the page can be made left and/or right and/or top and/or bottom justified.

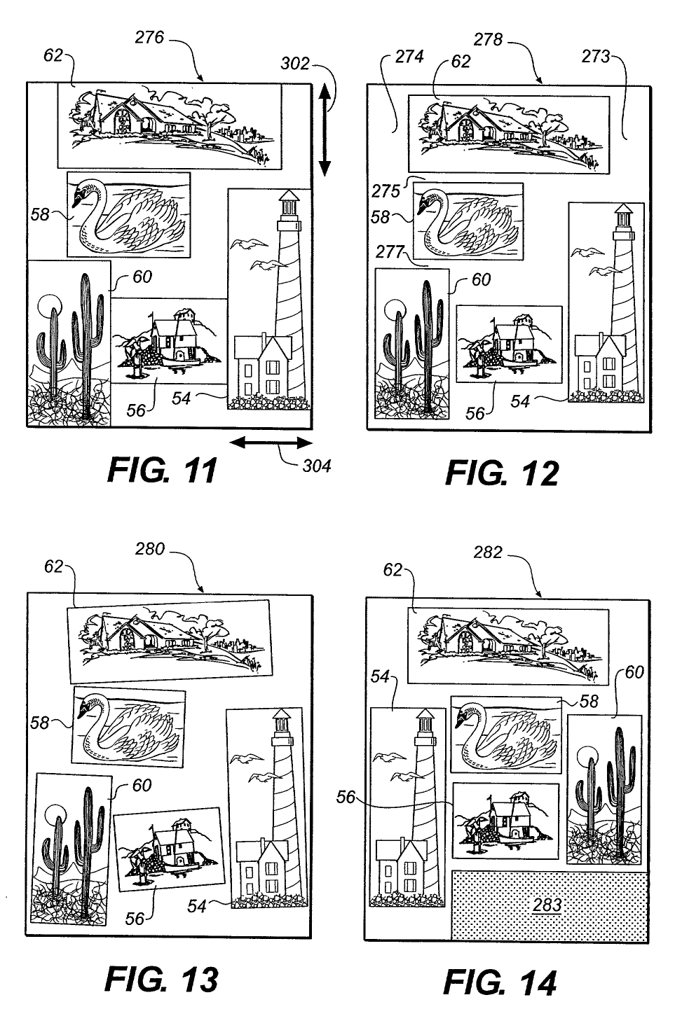

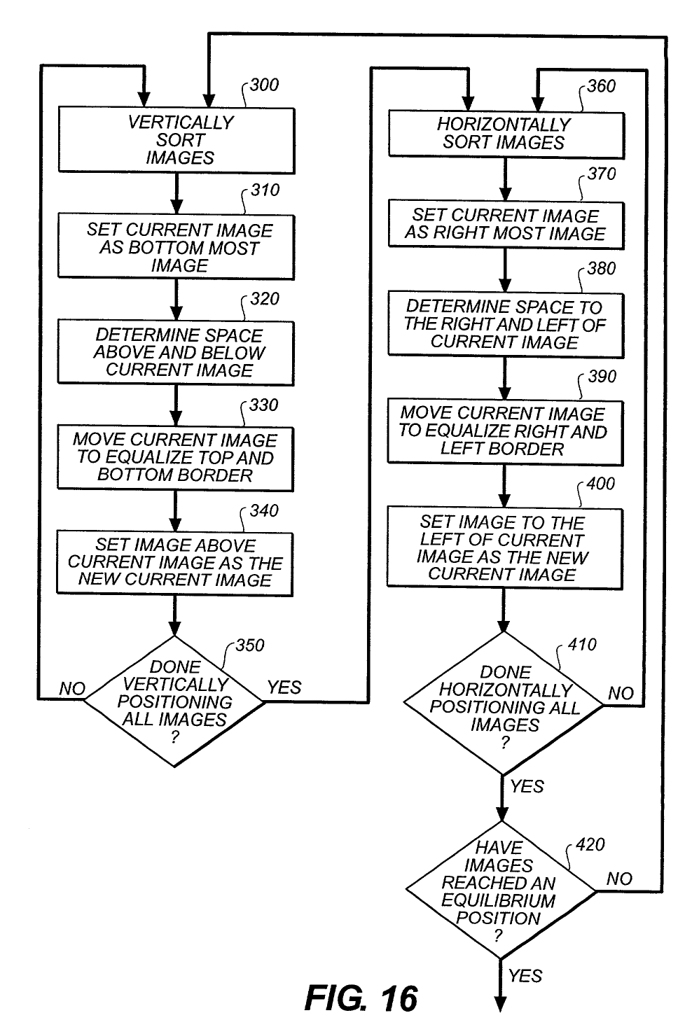

Referring to FIG. 16, there is shown a flow chart of an embodiment for spatially balancing the images and equalizing the top/bottom and right/left borders of the images on a page according to the present invention. It is of course understood that the process of equalizing the borders/spaces around an image may be executed by a variety of alternative methods and optimization techniques. The process of generating equal top/bottom and equal left/right borders around each image in the page layout is an iterative process where the vertical and horizontal spacing between the image are determined independently. At step 300, the n images are sorted according to their vertical (y) axis 302 (see FIG. 11). Next at step 310 the bottommost image is set to the current image. The spaces between the closest image or page boundary above and below the current image are determined at step 320. At step 330, the current image is moved vertically so that the spaces (borders) between itself and the image or page boundary above and below are equal. At step 340, the closest image above the current image is set as the new current image. Steps 320, 330, 340 and 350 are repeated until the topmost image has been repositioned. The analogous process is repeated at steps 360, 370, 380, 390, 400 and 410 for the horizontal spacing, as shown by arrow 304 in FIG. 11, between the images. The steps 300, 310, 320, 330, 340, 350, 360, 370, 380, 390, 400, 410 and 420 are then iterated until the images have reached their equilibrium position. That occurs when none of images are repositioned through a single iteration of steps 300, 310, 320, 330, 340, 350, 360, 370, 380, 390, 400 and 410. At this point images are spatially balanced and the borders between the images have been equalized.

FIG. 11 illustrates a page layout that was generated by equally distributing the images in the page layout 276 shown in FIG. 10. As shown in FIG. 11 some of the images are either touching each other and do not have white space between them or touching the boundary of the page. To ameliorate this look, the images can be scaled down and centered in their current locations. FIG. 12 illustrates a page layout 278 where the images in FIG. 11 have been scaled down by a factor of 0.95 and centered in their current locations.

To generate a more whimsical or scrapbook look the images can be randomly rotated or rotated in a predetermined pattern. The rotation of the images should be constraint such that the rotated images do not overlap or have a maximum overlap so as not to obscure important detail in the images. For example, no overlapping image which is greater than 10% or that avoids covering the central area of the image. FIG. 13 shows a page layout 280 where the images in page layout shown in FIG. 12 have been randomly rotated between −5 and +5.

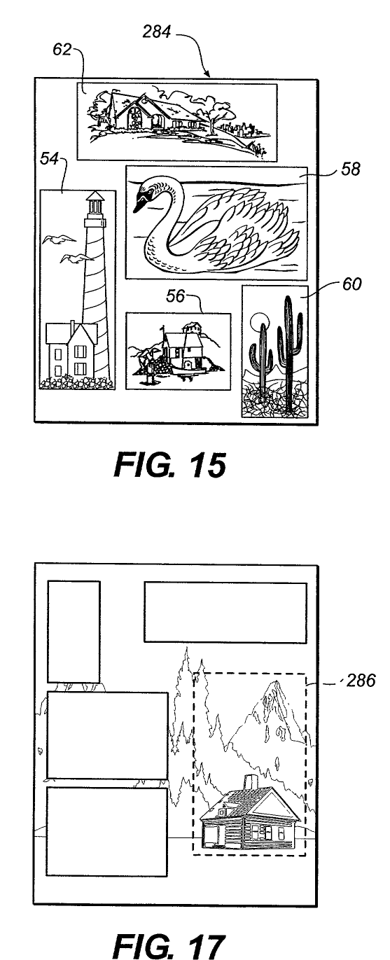

It is to be understood that various other modifications may be made. For example, but not by way of limitation, both the placement and scaling of the images can simultaneously be optimized in the calculation of the image page layout. The cost function can be generalized to contain many different goals in determining the page layout. Thus, in a further embodiment, the cost function can also take into account the aesthetic value in the calculation of the image page layout. In yet another embodiment of the invention, the optimization can minimize white space while simultaneously trying to avoid placing any images in a predefined location on the image page. FIG. 14 illustrates a page layout 282 where the five images 54, 56, 58, 60, and 62 were placed so as not to be in the predefined location 283 represented by the crosshatched region. This crosshatched region can treated like an area where an image is placed and subject to random rearrangement for different possible layouts. This area can be used to place text thereon or secure an item to the page by the customer when the page is received. While in the embodiment illustrated by FIG. 14, the location 283 is in the lower right area. However, location 283 may be anywhere on the page. For example, but not by way of limitation, location 283 may be in the center of the page with the images surrounding the location 283. This maybe especially useful when an image or artwork to be placed in the central location is related to the other images. In yet another embodiment, the location of a given image can be constrained to appear in a predefined location on the page layout. In yet another embodiment, the scaling factors used to scale the images can be constrained in such a way as to emphasis a given image relative to the other images. FIG. 15 illustrates a page layout 284 containing the five images 54, 56, 58, 60, and 62 were the scaling factors were set so as to emphasis image 58 over images 54, 56, 60, and 62.

In yet another embodiment a background may be selected in combination with the images to be placed on the page. For example, but not by way of limitation, a background such as a park, map, or other scenic background may be selected by the customer. This background may contain areas of interest to the customer that is desired to be substantially viewed. This is illustrated in FIG. 17 where the area of interest is shown by numeral 286. In such case the algorithm may be constrained so as to avoid the placement of the images in these area(s) of interest. The area of constraint may be of any size and/or shape that may be preprogrammed or selected by the customer. In addition, the background may be of a reduced display characteristic such as a lower color saturation, contrast or density, so as not to detract visually from the images placed on the page.

Optimization techniques try to find the global minimum, for example, the image layout that has the lowest possible amount of white space, but they are susceptible to being trapped in a local minimum. Since the process of optimizing the page layout is a random process, different optimal page layouts can be generated each time the same images and page format are run through the page layout subroutine 140. The system can automatically iterate through the page layout subroutine generating a predefined number of image page layouts. The page layout that has the highest score is then chosen as the preferred page layout. Though it should be noted that the most aesthetically pleasing page layout might not correspond to the page layout that has the minimum amount of white space.

The invention has been described in detail with particular reference to certain preferred embodiments thereof, but it will be understood that variations and modifications can be effected within the spirit and scope of the invention.

PARTS LIST

| | | | |
|---|---|---|---|
| 10. | system | 212. | trail page layout |
| 12. | personal computer | 220. | step |
| 20. | digital storage media | 222. | new trial page layout |
| 28. | scanner | 230. | step |
| 30. | digital camera | 240. | step |
| 40. | input device | 250. | step |
| 41. | page | 260. | step |
| 42. | template | 272. | new page layout |
| 43. | locations | 273. | left borders |
| 44. | locations | 274. | right borders |
| 45. | locations | 275. | bottom borders |
| 46. | locations | 276. | page layout |
| 47. | locations | 277 | bottom borders |
| 50. | display monitor | 278. | page layout |
| 54. | image | 282. | page layout |
| 56. | image | 283. | location |
| 58. | image | 284. | page layout |
| 60. | image | 286 | area of interest |
| 61. | printer | 300. | step |
| 62. | image | 302. | axis |
| 63. | server | 304. | arrow |
| 64. | network service provider | 310. | step |
| 70. | network | 320. | step |
| 80. | page | 330. | step |
| 100. | step | 340. | step |
| 110. | step | 350. | step |
| 120. | step | 360. | step |
| 130. | step | 370. | step |
| 140. | page layout subroutine | 380. | step |
| 150. | display | 390. | step |
| 160. | accept image | 400. | step |
| 170. | step | 410. | step |
| 200. | step | 420. | step |
| 210. | step | | |

What is claimed is:

1. A method of organizing a plurality of images including at least one image placeholder in a predetermined page format, comprising the steps of:
grouping said plurality of images into a plurality of different page layouts, wherein said plurality of images are not placed in said placeholder;
analyzing each of said different page layouts in accordance with a predetermined criteria; and
selecting the page layout based on said predetermined criteria.

2. A method according to claim 1 further comprising placing said plurality of images in said selected page layout.

3. A method according to claim 1 wherein said predetermined criteria comprises the amount of white space in each of said page layouts.

4. A method according to claim 3 wherein said analyzing said different page layouts comprises scoring each of said different page layouts.

5. A method according to claim 1 further comprising the step of further scaling the images of said selected page layout by different amounts.

6. A method according to claim 3 wherein the amount of white space is minimized by using stochastic algorithms.

7. A method according to claim 1 wherein said predetermined criteria includes placing images in said different page layouts in a non-overlapping pattern.

8. A method according to claim 1 wherein said placing of said plurality of images in said different page layouts comprises scaling all of said images such that they fit within said page format.

9. A method according to claim 1 wherein said analyzing of said different page layouts comprises a iteration of comparing sequentially two different page layouts and selecting the best page layout until little or no further improvement in scoring is obtained.

10. A method according to claim 9 further comprising the step of scaling individual images of the page layout obtained after said iteration.

11. A method according to claim 9 further comprising the step of rotating said images a predetermined amount.

12. A method according to claim 1 further comprising the step of spatially balancing the spacing between said images.

13. A method according to claim 1 further comprising the step of positioning said images in said selected page layout so as to provide a desired border on said page.

14. A method according to claim 12 wherein said white space is determined vertically between adjacent images in said page layouts.

15. A method according to claim 12 wherein said white space is determined horizontally between adjacent images in said page layouts.

16. A method of organizing a plurality of images in a predetermined page format including a background image, comprising the steps of:
identifying an image to be used as a background image;
grouping said plurality of images into a plurality of different page layouts including said background image;
analyzing each of said different page layouts in accordance with a predetermined criteria; and
selecting the page layout based on said predetermined criteria.

17. A method according to claim 16 wherein said background image is displayed with at least one reduced characteristic.

18. A method according to claim 17 wherein said at least one reduced characteristic is color saturation.

19. A method according to claim 17 further including the step of:
identifying at least one image to be placed at a predetermined image location.

20. A method according to claim 19 wherein said image is an image placeholder.

21. A method according to claim 20 wherein said image placeholder is correlated to an area of interest of said background image.

22. A method according to claim 16 further comprising placing said plurality of images in said selected page layout.

23. A method according to claim 16 wherein said predetermined criteria comprises the amount of white space in each of said page layouts.

24. A method according to claim 16 wherein said analyzing said different page layouts comprises scoring each of said different page layouts.

25. A method according to claim 16 further comprising the step of further scaling the images of said selected page layout by different amounts.

26. A method according to claim 23 wherein the amount of white space is minimized by using stochastic algorithms.

27. A method according to claim 16 wherein said predetermined criteria includes placing images in said different page layouts in a non-overlapping pattern.

28. A method according to claim 16 wherein said placing of said plurality of images in said different page layouts comprises scaling all of said images such that they fit within said page format.

29. A method according to claim 16 wherein said analyzing of said different page layouts comprises a iteration of comparing sequentially two different page layouts and selecting the best page layout until little or no further improvement in scoring is obtained.

30. A method according to claim 29 further comprising the step of scaling individual images of the page layout obtained after said iteration.

31. A method according to claim 29 further comprising the step of rotating said images a predetermined amount.

32. A method according to claim 16 further comprising the step of spatially balancing the spacing between said images.

33. A method according to claim 16 further comprising the step of positioning said images in said selected page layout so as to provide a desired border on said page.

34. A method according to claim 31 wherein said white space is determined vertically between adjacent images in said page layouts.

35. A method according to claim 23 wherein said white space is determined horizontally between adjacent images in said page layouts.

36. A computer software product for organizing a plurality of images in a predetermined format comprising a computer readable storage medium having a computer program which when loaded into a computer causes the computer to perform the following steps:
grouping said plurality of images into a plurality of different page layouts; wherein said plurality of images are not placed in a predefined area on said page;
analyzing each of said different page layouts in accordance with a predetermined criteria; and
selecting the page layout based on said predetermined criteria.

37. A method of organizing a plurality of images in a predetermined page format, comprising the steps of:
providing a plurality of digital images;
providing at least one image placeholder;
selecting a number of said images and said at least one image placeholder for placement on said predetermined format;
grouping said plurality of images and said image placeholder into a plurality of different page layouts;
analyzing each of said different page layouts in accordance with a predetermined criteria; and
selecting the page layout based on said predetermined criteria.

38. A method of organizing a first set of plurality of images in a predetermined page format, comprising the steps of:
grouping said plurality of images into a plurality of different page layouts, wherein said plurality of images are not placed in said placeholder;
analyzing each of said different page layouts in accordance with a predetermined criteria;
selecting the page layout based on said predetermined criteria; and
storing said selected page layout for later use.

39. A method according to claim 38 wherein said stored page layout is used with a second plurality set of images.
